(19) United States
(12) Patent Application Publication
(10) Pub. No.: US 2024/0048217 A1
(43) Pub. Date: Feb. 8, 2024

(54) RECEIVING APPARATUS AND RECEIVING METHOD

(71) Applicant: NIPPON TELEGRAPH AND TELEPHONE CORPORATION, Tokyo (JP)

(72) Inventors: Tomoki MURAKAMI, Tokyo (JP); Masashi IWABUCHI, Tokyo (JP); Riku OMIYA, Tokyo (JP); Tomoaki OGAWA, Tokyo (JP); Yasushi TAKATORI, Tokyo (JP)

(21) Appl. No.: 18/255,921

(22) PCT Filed: Dec. 7, 2020
(86) PCT No.: PCT/JP2020/045482

§ 371 Date: Jun. 5, 2023

(51) Int. Cl. H04B 7/08; H01Q 5/378; H01Q 3/44

(52) U.S. Cl. CPC H04B 7/0814; H01Q 5/378; H01Q 3/44; H04B 7/0413

(57) ABSTRACT

A receiving apparatus comprising: an antenna control unit; a variable characteristic antenna that receives MIMO signals transmitted from a plurality of antennas while switching an antenna characteristic on the basis of a control signal output from the antenna control unit; a conversion unit that samples reception signals received by the variable characteristic antenna at a predetermined sampling period; a signal division unit that extracts each signal from a plurality of signals corresponding to a plurality of antenna characteristics obtained by the conversion unit; and a MIMO signal demodulation unit that performs MIMO demodulation processing on a signal output from the signal division unit, wherein the variable characteristic antenna includes a plurality of parasitic elements, and the antenna control unit outputs a control signal to each of the parasitic elements by providing a time difference among the control signals.

### TECHNICAL FIELD

The present invention relates to a wireless communication system that performs multiple input multiple output (MIMO) communication.

### BACKGROUND ART

Due to the rapid spread of wireless devices, wireless communication traffic continues to increase. To stably accommodate the wireless communication traffic, an increase in the capacity of a wireless communication system is required. In order to achieve a large capacity of a wireless communication system, MIMO that performs space-division multiplexing transmission at the same frequency at the same time using a plurality of antennas has been put into practical use. Furthermore, for a future wireless communication system, research and development of massive MIMO using an extremely large number of antennas has been advanced to further expand the capacity achieved by MIMO.

However, Massive MIMO has a problem that the size and cost of a wireless base station increase because the wireless base station requires an extremely large number of antennas, RF units performing amplification, filtering, and the like connected to the antennas, conversion units converting analog and digital signals, and the like.

In order to solve the above problem, Non Patent Literature 1 discloses a technology of virtual massive MIMO (VM-MIMO). In virtual massive MIMO (VM-MIMO) disclosed in Non Patent Literature 1, in uplink massive MIMO, a wireless base station receives signals transmitted from a plurality of antennas at the same frequency at the same time while periodically switching an antenna characteristic at high speed by a variable characteristic antenna. Furthermore, signals at timings at which antenna characteristics are equivalent are divided and extracted from reception signals sampled at a higher speed than usual, and general multiuser MIMO reception processing is performed on the extracted signals, so that massive MIMO can be received with fewer antennas.

### CITATION LIST

### Non Patent Literature

Non Patent Literature 1: Murakami et al., “Space-time signal processing technology in future wireless systems” The Institute of Electronics, Information and Communication Engineers Society Conference 2019

### SUMMARY OF INVENTION

### Technical Problem

As described above, since reception of massive MIMO can be achieved with a small number of antennas by the VM-MIMO technology, the size and cost of a wireless base station can be reduced. As an element for determining the transmission quality of VM-MIMO, high-speed antenna characteristic switching synchronized with the sampling frequency is required.

As one of means for making the antenna characteristic variable, a configuration is conceivable in which the antenna element length is changed by changing the capacitance using a varactor diode such as an electronically steerable passive array radiator (ESPAR) antenna. However, there is a possibility that VM-MIMO cannot be achieved because it is difficult to achieve high speed when varying the antenna characteristic by a variable capacitance. Note that such a problem can occur not only in a wireless base station that performs reception processing of VM-MIMO but also in a radio terminal station that performs reception processing of VM-MIMO.

The present invention has been made in view of the above points, and aims to provide a technology that enables high-speed switching of an antenna characteristic in a reception device that receives, by a variable characteristic antenna, MIMO signals transmitted at the same frequency at the same time from a plurality of antennas of a transmission device.

### Solution to Problem

According to the disclosed technology, there is provided a reception device including:
an antenna control unit;
a variable characteristic antenna that receives MIMO signals transmitted from a plurality of antennas while switching an antenna characteristic on the basis of a control signal output from the antenna control unit;
a conversion unit that samples reception signals received by the variable characteristic antenna at a predetermined sampling period;
a signal division unit that extracts each signal from a plurality of signals corresponding to a plurality of antenna characteristics obtained by the conversion unit; and
a MIMO signal demodulation unit that performs MIMO demodulation processing on a signal output from the signal division unit, in which
the variable characteristic antenna includes a plurality of parasitic elements, and the antenna control unit outputs a control signal to each of the parasitic elements by providing a time difference among the control signals.

### Advantageous Effects of Invention

According to the disclosed technology,

According to the disclosed technology, there is provided a technology that enables high-speed switching of an antenna characteristic in a reception device that receives, by a variable characteristic antenna, MIMO signals transmitted at the same frequency and the same time from a plurality of antennas of a transmission device.

### BRIEF DESCRIPTION OF DRAWINGS

FIG. 1 is a system configuration diagram in an embodiment of the present invention.

FIG. 2 is a system configuration diagram in the embodiment of the present invention.

FIG. 3 is a diagram for describing an operation of VM-MIMO.

FIG. 4 is a configuration diagram of a wireless terminal station.

FIG. 5 is a configuration diagram of a wireless base station.

FIG. 6 is a configuration diagram of a wireless base station.

FIG. 7 is a flowchart illustrating an operation of the wireless base station.

FIG. 8 is a configuration diagram of a variable characteristic antenna.

FIG. 9 is a diagram for describing an arrangement of parasitic elements.

FIG. 10 is a diagram for describing an example of control by a control signal.

FIG. 11 is a configuration diagram of a variable characteristic antenna.

FIG. 12 is a diagram for describing an example of control by a control signal.

### DESCRIPTION OF EMBODIMENTS

Hereinafter, an embodiment of the present invention (present embodiment) will be described with reference to the drawings. The embodiment described below is merely an example, and the embodiment to which the present invention is applied is not limited to the following embodiment.

Note that in the following description, an example is used in which a wireless terminal station 1 is used as a transmission device and a wireless base station 2 is used as a reception device (receiving apparatus). However, the technology according to the present invention can be applied to the reception device even in a case where the wireless base station 2 is used as the transmission device and the wireless terminal station 1 is used as the reception device.

(Overall Configuration)

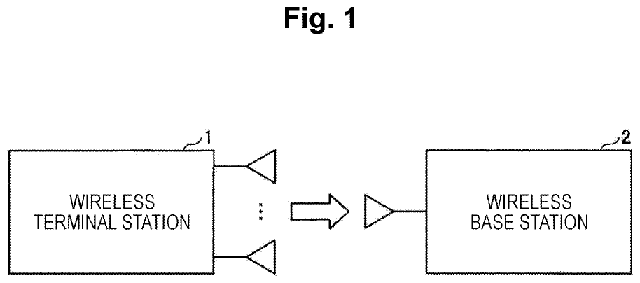

FIG. 1 illustrates a configuration example of a wireless communication system in the present embodiment. As illustrated in FIG. 1, the wireless communication system in the present embodiment includes the wireless terminal station 1 and the wireless base station 2. The wireless terminal station 1 includes a plurality of antennas, and the wireless base station 2 includes one variable characteristic antenna. There may be a plurality of variable characteristic antennas in the wireless base station 2. As illustrated in FIG. 1, in the present embodiment, uplink communication from the wireless terminal station 1 to the wireless base station 2 is targeted.

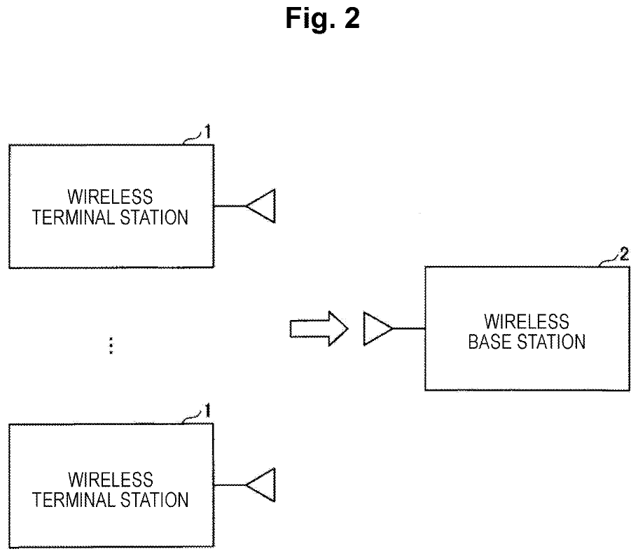

Note that while it is assumed in the present embodiment that the wireless base station 2 receives a signal transmitted from one wireless terminal station 1 as illustrated in FIG. 1, this is an example. As illustrated in FIG. 2, the technology according to the present embodiment is also applicable to a case where the wireless base station 2 receives signals transmitted from a plurality of wireless terminal stations 1 (i.e., case of multiuser MIMO).

(Outline of Operation of Wireless Communication System)

The wireless base station 2 performs massive MIMO reception with one variable characteristic antenna by the technology of virtual massive MIMO (VM-MIMO) disclosed in Non Patent Literature 1.

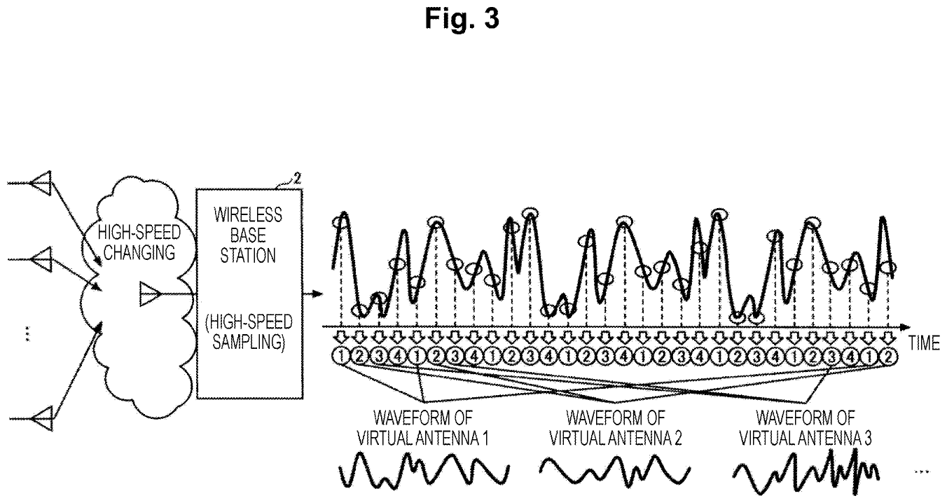

That is, as illustrated in FIG. 3, the wireless base station 2 receives signals transmitted from a plurality of antennas of the wireless terminal station 1 at the same frequency at the same time while periodically changing the antenna characteristic at high speed. The wireless base station 2 samples reception signals at a higher speed than usual, divides and extracts reception signals at timings at which antenna characteristics are equivalent from the sampled reception signals, and performs general MIMO reception processing on the extracted reception signals, thereby enabling massive MIMO reception with one variable characteristic antenna.

Theoretically, the extracted reception signals can be regarded as signals arriving from different propagation paths. Hence, the number of antennas can be virtually increased, and massive MIMO can be received.

In the example of FIG. 3, the wireless base station 2 receives the signals while switching among four antenna characteristics 1 to 4 periodically. In the example of FIG. 3, the signal at the timing of the antenna characteristic 1 is indicated by “1”, the signal at the timing of the antenna characteristic 2 is indicated by “2”, the signal at the timing of the antenna characteristic 3 is indicated by “3”, and the signal at the timing of the antenna characteristic 4 is indicated by “4”.

Furthermore, the antennas having the antenna characteristics 1 to 4 are referred to as virtual antennas 1 to 4. In FIG. 3, a waveform of the signal indicated by “1” is illustrated as a waveform of the virtual antenna 1.

By using the VM-MIMO technology, it is possible to demodulate the MIMO signal transmitted from the plurality of antennas of the wireless terminal station 1 using one variable characteristic antenna of the wireless base station 2.

However, as described above, when the varactor diode is used as in an ESPAR antenna as one of the means for changing the antenna characteristic, there is a possibility that VM-MIMO cannot be achieved because high speed is difficult to achieve.

Therefore, in the present embodiment, a variable characteristic antenna using a variable phase shifter capable of high-speed switching is used. Hereinafter, the configuration and operation of each device will be described.

(Wireless Terminal Station 1)

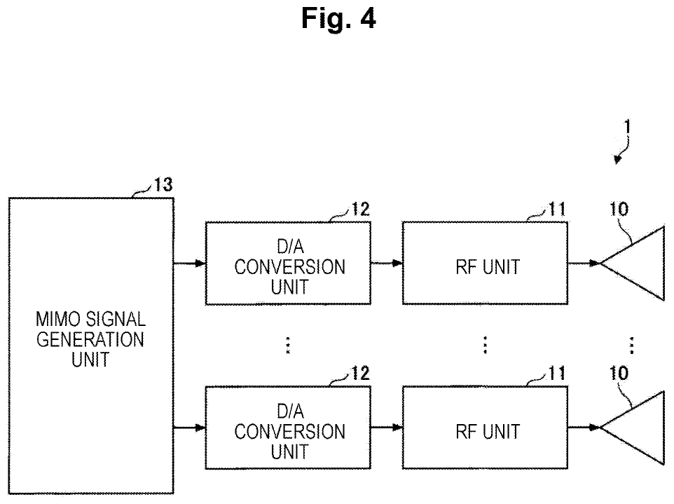

FIG. 4 illustrates a configuration example of the wireless terminal station 1 in the present embodiment. As illustrated in FIG. 4, the wireless terminal station 1 includes a plurality of antennas 10, a plurality of RF units 11, a plurality of D/A conversion units 12, and a MIMO signal generation unit 13. Note that functional blocks generally mounted on the wireless terminal station 1 are omitted.

The MIMO signal generation unit 13 generates a plurality of MIMO signals from transmission data, and inputs the MIMO signals to the D/A conversion units 12. The D/A conversion unit 12 converts the input MIMO signal into an analog signal, and outputs the analog signal to the RF unit 11.

The RF unit 11 performs analog processing such as amplification, frequency conversion, and filtering on the analog signal, and outputs the processed signal to each antenna 10. Here, it is assumed that a function of an RF front end of a general wireless device is mounted as the RF unit 11. The antenna 10 radiates the input signal into the air as a wireless signal.

(Wireless Base Station 2)

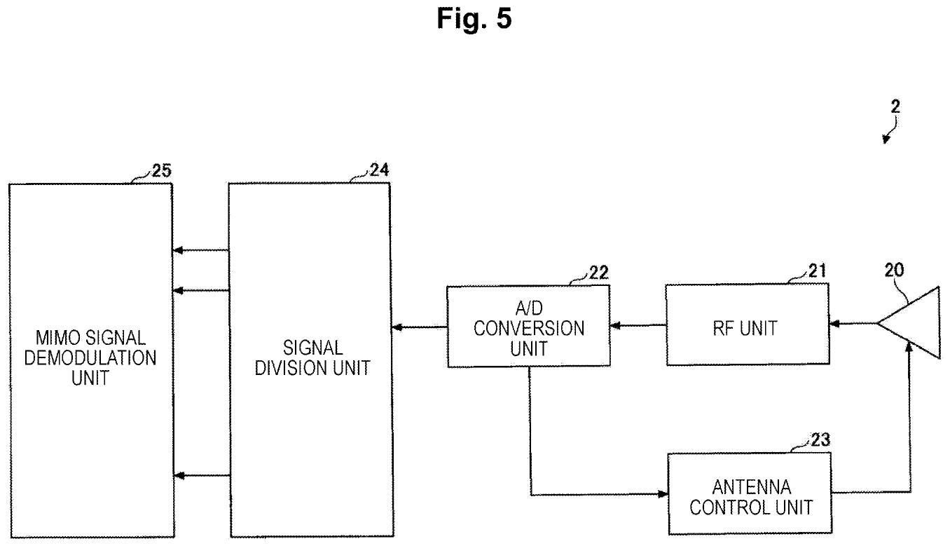

FIG. 5 illustrates a configuration example of the wireless base station 2 in the present embodiment. As illustrated in FIG. 5, the wireless base station 2 in the present embodiment includes a variable characteristic antenna 20, an RF unit 21, an A/D conversion unit 22, an antenna control unit 23, a signal division unit 24, and a MIMO signal demodulation unit 25. Note that functional blocks generally mounted on a wireless base station are omitted. Functions of the units of the wireless base station 2 are as follows.

The variable characteristic antenna 20 is an antenna that periodically switches the antenna characteristic (directivity, output power, phase, and the like) depending on a control signal input from the antenna control unit 23. A detailed configuration example of the variable characteristic antenna 20 will be described later.

The RF unit 21 performs processing such as amplification, frequency change, and filtering on the signal input from the variable characteristic antenna 20, and outputs the processed signal to the A/D conversion unit 22. Here, it is assumed that a function of an RF front end of a general wireless device is mounted as the RF unit 21.

The A/D conversion unit 22 samples the analog signal input from the RF unit 21 to convert the analog signal into a digital signal, and outputs the digital signal to the signal division unit 24. Furthermore, the A/D conversion unit 22 notifies the antenna control unit 23 of a sampling period.

The antenna control unit 23 outputs a control signal synchronized with the sampling period of the A/D conversion unit 22 to the variable characteristic antenna 20.

The signal division unit 24 divides a plurality of signals having different characteristics input from the A/D conversion unit 22 in synchronization with the sampling period, and outputs a signal obtained by the division to the MIMO signal demodulation unit 25.

The MIMO signal demodulation unit 25 performs MIMO demodulation processing defined by a general wireless communication system on the signal received from the signal division unit 24.

Here, in the variable characteristic antenna 20, in a case where the antenna characteristic is periodically switched by periodically selecting one of four virtual antennas, for example, the A/D conversion unit 22 samples and outputs signals 1 to 4 corresponding to the antenna characteristics at a sampling period that is four times or more the sampling period of the A/D conversion unit 22 of a general wireless base station.

The antenna control unit 23 selects one of the four virtual antennas at the sampling period of the A/D conversion unit 22 and switches the antenna characteristic.

At this time, the signal division unit 24 divides and extracts the signals 1 to 4 corresponding to the antenna characteristics at the same sampling period as the sampling period of the A/D conversion unit 22, and outputs the signals to the MIMO signal demodulation unit 25. As a result, the signals 1 to 4 having the same antenna characteristics are periodically output to four output ports of the signal division unit 24.

### Other Configuration Examples

The function of each functional block in the wireless base station 2 illustrated in FIG. 5 may be implemented by dedicated hardware (LSI or the like), or a part (i.e., part that performs digital signal processing) other than “variable characteristic antenna 20, RF unit 21, and A/D conversion unit 22” may be implemented by a general-purpose computer including a processor (CPU, DSP, or the like) and a memory, and software operating on the computer.

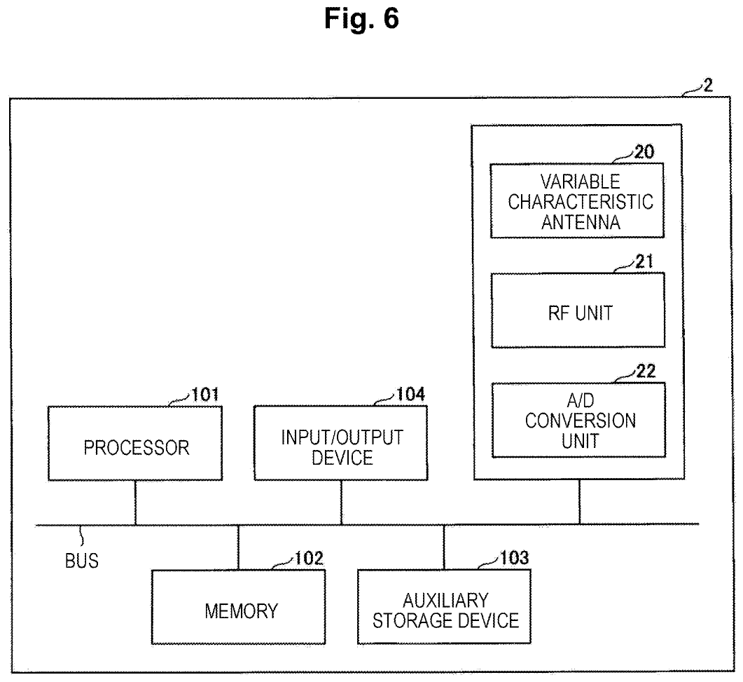

FIG. 6 illustrates a configuration example of the wireless base station 2 in a case where the wireless base station 2 is implemented using a computer and software.

As illustrated in FIG. 6, the wireless base station 2 includes a processor 101, a memory 102, an auxiliary storage device 103, an input/output device 104, the variable characteristic antenna 20, the RF unit 21, and the A/D conversion unit 22, and has a configuration in which these are connected to each other by a bus.

For example, a program for implementing operation of the wireless base station 2 is stored in the auxiliary storage device 103 (storage medium). When the wireless base station 2 operates, the program is read into the memory 102, and the processor 101 reads and executes the program from the memory 102. For example, the processor 101 executes processing of the antenna control unit 23, the signal division unit 24, and the MIMO signal demodulation unit 25 by the program.

The input/output device 104 outputs, for example, a signal obtained by the MIMO signal demodulation unit 25. Furthermore, information to be set in advance may be input from the input/output device 104.

### Operation Example

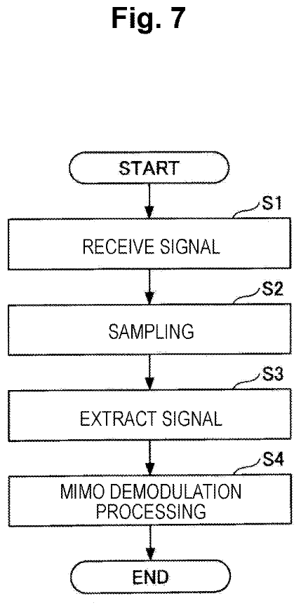

Next, an example of a time-series operation of the wireless base station 2 will be described with reference to the flowchart of FIG. 7. The antenna control unit 23 outputs a control signal synchronized with the sampling period of the A/D conversion unit 22 to the variable characteristic antenna 20, and the variable characteristic antenna 20 periodically switches the antenna characteristic in accordance with the antenna control signal. Details of the control by the control signal will be described later.

<S1>

In S1 (step 1), the variable characteristic antenna 20 receives signals simultaneously transmitted from a plurality of antennas of the wireless terminal station 1. The received signal is input to the RF unit 21, and the signal processed by the RF unit 21 is output to the A/D conversion unit 22.

<S2>

In S2, the A/D conversion unit 22 samples an input signal (analog signal) and acquires a sampled signal (digital signal). A “signal” in the following description is a signal acquired by sampling. The signal obtained by the A/D conversion unit 22 is output to the signal division unit 24.

<S3>

In S3, the signal division unit 24 divides and extracts the signal input from the A/D conversion unit 22 at the same sampling period as the sampling period of the A/D conversion unit 22, and outputs the extracted signal to the MIMO signal demodulation unit 25.

<S4>

In S4, the MIMO signal demodulation unit 25 performs MIMO demodulation processing defined by a general wireless communication system on the signal received from the signal division unit 24. Note that information required in the MIMO demodulation processing (e.g., number of antennas of wireless terminal station 1) may be given in advance or may be estimated.

(Configuration Example of Variable Characteristic Antenna)

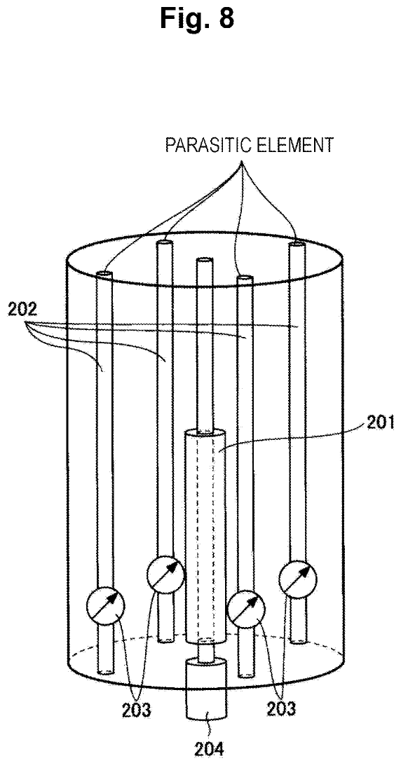

FIG. 8 illustrates a configuration example of the variable characteristic antenna 20 in the present embodiment. The variable characteristic antenna 20 illustrated in FIG. 8 includes a feed element disposed at the center and a plurality of parasitic elements disposed around the feed element, and the antenna control unit 23 changes the characteristic of the parasitic elements, thereby changing the characteristic of the antenna. The variable characteristic antenna 20 illustrated in FIG. 8 receives electromagnetic waves transmitted from the wireless terminal station 1. The variable characteristic antenna 20 can also transmit electromagnetic waves of a signal including data to the wireless terminal station 1.

More specifically, as illustrated in FIG. 8, the variable characteristic antenna 20 includes an antenna element 201, four parasitic elements 202, four variable phase shifters 203, and a connection unit 204. Note that while this example is a case where the variable characteristic antenna 20 has four parasitic elements, but there may be three or less or five or more parasitic elements.

The antenna element 201 is, for example, a sleeve antenna, and has an element length of ½ wavelength in the Z-axis direction (height direction in FIG. 8). The antenna element 201 is disposed so as to extend in the Z-axis direction perpendicular to the XY plane of the horizontal plane.

The antenna element 201 can transmit a signal including data from the wireless base station 2 to the wireless terminal station 1 by electromagnetic waves via the connection unit 204. In addition, the variable characteristic antenna 20 receives electromagnetic waves transmitted from the wireless terminal station 1, and outputs a signal of the electromagnetic waves received via the connection unit 204 into the wireless base station 2. Note that the variable characteristic antenna 20 may be a dipole antenna or the like.

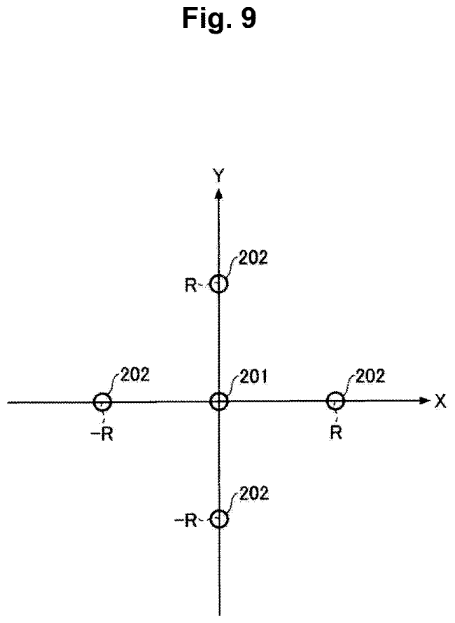

The parasitic elements 202 are arranged on the XY plane at equal intervals on a circumference with a radius R around a position where the antenna element 201 is arranged. That is, as illustrated in FIG. 9, the positions of the parasitic elements 202 are (R, 0), (0, R), (−R, 0), and (0, −R) when the position of the antenna element 201 is the origin of the XY plane. Note that the radius R is set to a distance equal to or longer than ⅛ wavelength at a free space wavelength capable of reducing the influence of mutual coupling with the antenna element 201. In addition, the number of parasitic elements 202 to be arranged may be other than four. The antenna element 201 and the parasitic element 202 operate as an antenna unit.

As illustrated in FIG. 8, the parasitic element 202 includes, for example, a cylindrical member made of metal such as copper, and the variable phase shifter 203. The metal member is connected via the phase shifter 203. The phase of the parasitic element 202 is adjusted according to a voltage applied from the power source of the variable characteristic antenna 20 or the power source included in the wireless base station 2 to the phase shifter 203. Note that a characteristic other than the phase may be adjusted.

For example, in a case where no voltage is applied to the variable phase shifter 203, the variable characteristic antenna 20 receives a signal at a certain phase (outputs signal to wireless base station 2), and on the other hand, in a case where a voltage is applied to the variable phase shifter 203, the variable characteristic antenna 20 receives a signal at a phase different from the above phase. Furthermore, for example, in a case where no voltage is applied to the variable phase shifter 203, a signal is emitted at a certain phase, and on the other hand, in a case where a voltage is applied to the variable phase shifter 203, a signal is emitted at a phase different from the above phase.

The connection unit 204 is an antenna connector or the like, and connects the variable characteristic antenna 20 and the wireless base station 2 by a coaxial cable or the like. Then, the connection unit 204 outputs the signal of the electromagnetic waves received by the variable characteristic antenna 20 to the wireless base station 2, and outputs a signal including data from the wireless base station 2 to the variable characteristic antenna 20.

(Antenna Control Example)

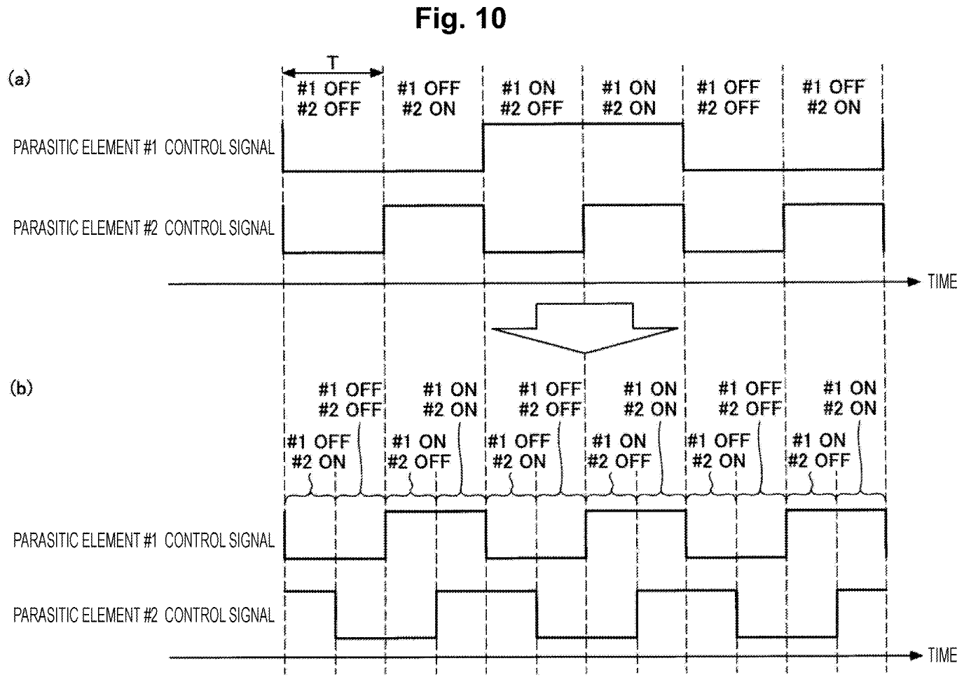

FIG. 10 illustrates an example of a control signal input from the antenna control unit 23 to the variable characteristic antenna 20. In FIG. 10, a voltage is supplied to the variable phase shifter 203 of a corresponding parasitic element 202 in the “ON” state, and no voltage is supplied in the “OFF” state. In FIGS. 10(a) and 10(b), the vertical axis represents ON/OFF, and the horizontal axis represents time. Note that the vertical axis may represent the voltage.

FIG. 10(a) is an example of a conventional control signal illustrated for comparison, and illustrates control signals for two parasitic elements. As illustrated in FIG. 10(a), by synchronously controlling ON and OFF of the control signals, four states are periodically changed. Each state corresponds to one antenna characteristic of the variable characteristic antenna 20. That is, in the example of FIG. 10(a), the timings between the rise and fall of the control signals are the same and synchronized.

A cycle (T) illustrated in FIG. 10 is, for example, the shortest cycle as a cycle for changing the characteristic of each parasitic element. In the example of FIG. 10(a), the antenna characteristic of the variable characteristic antenna 20 can only be changed in this cycle, and there is a possibility that it is not sufficient to achieve VM-MIMO.

On the other hand, FIG. 10(b) is an example of a control signal in the present embodiment. As illustrated in FIG. 10(b), the antenna control unit 23 can change the antenna characteristic of the variable characteristic antenna 20 at a higher speed than in the case of the example illustrated in FIG. 10(a) by shifting the output timing of some of the plurality of control signals from that of other control signals. That is, by providing a time difference between control signals for the plurality of parasitic elements, high-speed characteristic variation is achieved.

More specifically, in the case of FIG. 10(b), the output timing of the control signal to the parasitic element #2 (input timing to variable phase shifter 203) is shifted from the output timing of the control signal to the parasitic element #1 by a half (T/2) of the cycle T in which the characteristic of each parasitic element is changed. As a result, the antenna characteristic of the variable characteristic antenna 20 can be changed twice as fast as when the output timing is not shifted.

While FIG. 10 illustrates an example of a case where two parasitic elements are used, a high-speed change in the antenna characteristic of the variable characteristic antenna 20 can similarly be achieved in a case where three or more parasitic elements are used by shifting the output timing of the control signal among the parasitic elements. For example, in a case where four parasitic elements #1 to #4 are used, the output timing of the control signal to the parasitic element #2 is shifted by T/4 from the output timing to the parasitic element #1, the output timing of the control signal to the parasitic element #3 is shifted by T/4 from the output timing to the parasitic element #2, and the output timing of the control signal to the parasitic element #4 is shifted by T/4 from the output timing to the parasitic element #3, so that the antenna characteristic of the variable characteristic antenna 20 can be changed at a speed four times faster than the conventional technology.

(Modification)

While the basic configuration has been described as a basic example, configurations and operations described in the following modifications may be adopted for further improvement in characteristic. Note that part or all of the modifications may be combined. In addition, the basic example described above is applied to parts not described in the modifications.

<Modification 1>

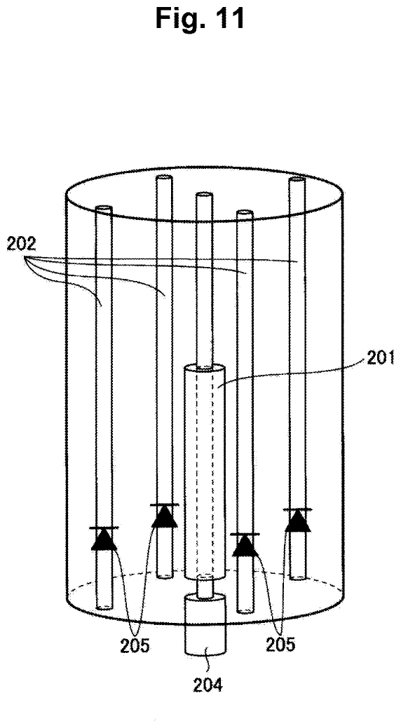

In Modification 1, as illustrated in FIG. 11, a diode switch 205 is used instead of the variable phase shifter 203 in a variable characteristic antenna 20. Even in the case of using the diode switch 205, the operation by the control signal described with reference to FIG. 10 is the same as the operation in the case of the variable phase shifter 203. In addition, even in the case of using the diode switch 205, the effect is the same as that in the case of using the variable phase shifter 203 in that the characteristic such as the phase of the transmission/reception signal of the variable characteristic antenna 20 can be changed.

Note, however, that while the diode switch 205 is limited to ON/OFF control as illustrated in FIG. 10, the variable phase shifter 203 is capable of a more diverse control pattern than the diode switch 205. Note that the variable phase shifter 203 and the diode switch 205 may be collectively referred to as a phase variable unit.

<Modification 2>

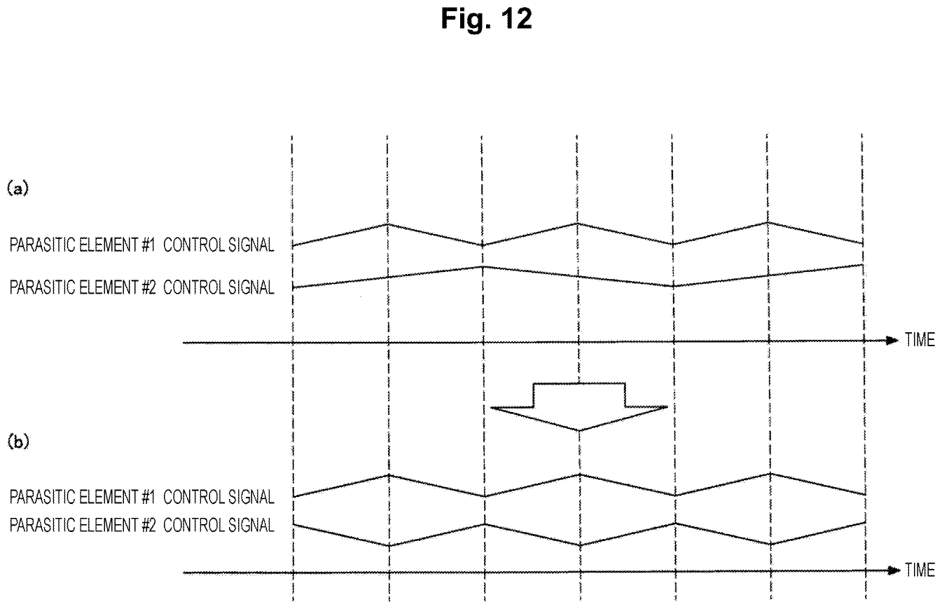

In Modification 2, a voltage-control type (analog control) attenuator or phase shifter is used as the phase variable unit. As a result, an analog signal as illustrated in FIG. 12 can be used as the control signal instead of the ON/OFF control signal (digital signal) as described with reference to FIG. 10. As a result, the state of the antenna characteristic can be changed more frequently, and the speed of the change can also be increased by shifting the output timing of the control signal.

FIGS. 12(a) and 12(b) illustrate control signals to parasitic elements in a case where two parasitic elements are used as in FIG. 10. In FIGS. 12(a) and 12(b), the vertical axis represents the voltage, and the horizontal axis represents time. FIG. 12(a) illustrates a state in which the timing of the control signal is not shifted, and FIG. 12(b) illustrates a state in which the timing of the control signal is shifted.

### Effects of Embodiments

As described above, in the present embodiment, in the reception device that receives, by the variable characteristic antenna, MIMO signals transmitted from a plurality of antennas of the transmission device at the same frequency at the same time, the antenna characteristic can be changed at high speed by providing a time difference among the control signals of the parasitic elements.

(Supplement)

In the present specification, at least a reception device or a reception method described in clauses described below is described.

### (Clause 1)

A reception device including:
an antenna control unit;
a variable characteristic antenna that receives MIMO signals transmitted from a plurality of antennas while switching an antenna characteristic on the basis of a control signal output from the antenna control unit;
a conversion unit that samples reception signals received by the variable characteristic antenna at a predetermined sampling period;
a signal division unit that extracts each signal from a plurality of signals corresponding to a plurality of antenna characteristics obtained by the conversion unit; and
a MIMO signal demodulation unit that performs MIMO demodulation processing on a signal output from the signal division unit, in which
the variable characteristic antenna includes a plurality of parasitic elements, and the antenna control unit outputs a control signal to each of the parasitic elements by providing a time difference among the control signals.

### (Clause 2)

The reception device according to clause 1, in which
each parasitic element in the variable characteristic antenna includes a phase variable unit, and the control signal controls the phase variable unit.

### (Clause 3)

The reception device according to clause 2, in which
the phase variable unit is a voltage-control type phase variable unit, and the control signal is an analog signal.

### (Clause 4)

A reception method executed by a reception device including an antenna control unit and a variable characteristic antenna, the reception method including the steps of:
receiving MIMO signals transmitted from a plurality of antennas while switching an antenna characteristic on the basis of a control signal output from the antenna control unit;
sampling reception signals received by the variable characteristic antenna at a predetermined sampling period;
extracting each signal from a plurality of signals corresponding to a plurality of antenna characteristics obtained by the sampling; and
performing MIMO demodulation processing on the extracted signal, in which
the variable characteristic antenna includes a plurality of parasitic elements, and the antenna control unit outputs a control signal to each of the parasitic elements by providing a time difference among the control signals.

While the present embodiment has been described above, the present invention is not limited to such a specific embodiment, and various modifications and changes can be made within the scope of the gist of the present invention described in the claims.

### REFERENCE SIGNS LIST

1 Wireless terminal station
2 Wireless base station
10 Antenna
11 RF unit
12 D/A conversion unit
13 MIMO signal generation unit
20 Variable characteristic antenna
21 RF unit
22 A/D conversion unit
23 Antenna control unit
24 Signal division unit
25 MIMO signal demodulation unit
101 Processor
102 Memory
103 Auxiliary storage device
104 Input/output device
201 Antenna element
202 Parasitic element
203 Variable phase shifter
204 Connection unit
205 Diode switch

1. A receiving apparatus comprising:
a processor; and
a memory that includes instructions, which when executed, cause the processor to execute:
receiving, by a variable characteristic antenna, MIMO signals transmitted from a plurality of antennas while switching an antenna characteristic on the basis of a control signal output from an antenna control unit included in the receiving apparatus;
sampling, by a conversion unit, reception signals received by the variable characteristic antenna at a predetermined sampling period;
extracting, by a signal division unit, each signal from a plurality of signals corresponding to a plurality of antenna characteristics obtained by the conversion unit; and
performing, by a MIMO signal demodulation unit, MIMO demodulation processing on a signal output from the signal division unit, wherein
the variable characteristic antenna includes a plurality of parasitic elements, and the antenna control unit outputs a control signal to each of the parasitic elements by providing a time difference among the control signals.

2. The receiving apparatus according to claim 1, wherein
each parasitic element in the variable characteristic antenna includes a phase variable unit, and the control signal controls the phase variable unit.

3. The receiving apparatus according to claim 2, wherein
the phase variable unit is a voltage-control type phase variable unit, and the control signal is an analog signal.

4. A receiving method executed by a computer in a receiving apparatus including an antenna control unit and a variable characteristic antenna, the receiving method comprising:
receiving MIMO signals transmitted from a plurality of antennas while switching an antenna characteristic on the basis of a control signal output from the antenna control unit;
sampling reception signals received by the variable characteristic antenna at a predetermined sampling period;
extracting each signal from a plurality of signals corresponding to a plurality of antenna characteristics obtained by the sampling; and
performing MIMO demodulation processing on the extracted signal, wherein
the variable characteristic antenna includes a plurality of parasitic elements, and the antenna control unit outputs a control signal to each of the parasitic elements by providing a time difference among the control signals.
